(19) United States
(12) Patent Application Publication
(10) Pub. No.: US 2023/0025058 A1
(43) Pub. Date: Jan. 26, 2023

(54) IMAGE RECTIFICATION METHOD AND DEVICE, AND ELECTRONIC SYSTEM

(71) Applicant: MEGVII (BEIJING) TECHNOLOGY CO., LTD., Beijing (CN)

(72) Inventors: Gang HU, Beijing (CN); Lu YANG, Beijing (CN)

(21) Appl. No.: 17/758,369

(22) PCT Filed: Sep. 30, 2020
(86) PCT No.: PCT/CN2020/119463

§ 371 Date: Jul. 5, 2022

(30) Foreign Application Priority Data
Mar. 23, 2020 (CN) 202010210390.0

(51) Int. Cl. G06T 7/80; G06T 5/00; G06V 10/44; G06V 10/74; G06V 10/98

(52) U.S. Cl. CPC G06T 7/80; G06T 5/006; G06V 10/44; G06V 10/761; G06V 10/98; G06T 2207/10148

(57) ABSTRACT

Provided are an image rectification method and apparatus, and an electronic system. The image rectification method includes: acquiring a first image and a second image of the same shooting object by means of a first shooting apparatus and a second shooting apparatus which are coaxially disposed; and correcting the second image according to shooting parameters of the first shooting apparatus and the second shooting apparatus to obtain a second rectified image, such that the parallax between the second rectified image and the first image in a vertical direction or a horizontal direction is zero. In the method, by taking a first image as a reference, and by means of adjusting the shooting parameters of the first shooting apparatus and a second shooting apparatus, only the second image is rectified, thereby improving the operation efficiency of image rectification, and improving the accuracy and stability of an image rectification result.

### CROSS-REFERENCE TO RELATED APPLICATION

This application claims priority of the Chinese patent application No. 202010210390.0, filed on Mar. 23, 2020, and entitled “image rectification method, apparatus and electronic system”, and the entire content disclosed by the Chinese patent application is incorporated herein by reference as part of the present application.

### TECHNICAL FIELD

The present application relates to a field of image rectification technologies, and in particular, to an image rectification method, an apparatus and an electronic system.

### BACKGROUND

Image stereo rectification means that two images are respectively subjected to a plane projective transformation to make the epipolar lines of the two images in the same horizontal direction and the epipolar points are mapped to infinity, so that there is only parallax in the horizontal direction between the two images. In this way, the stereo matching problem is reduced from two-dimensional to one-dimensional, thereby improving the matching speed.

In the related art, a variety of existing methods may be used to achieve image stereo rectification. However, these methods are either complex in calculation, low in operation efficiency, or poor in the stability of rectification results, making it difficult to be practically applied to terminal device, such as the mobile phone, which requires both efficient operation and accurate and stable rectification results.

### SUMMARY

An objective of the present application is to provide an image rectification method, a rectification apparatus and an electronic system, to improve the operation efficiency of image rectification and improve the accuracy and stability of image rectification results.

The embodiment of the present application provides an image rectification method, the method includes: obtaining a first image and a second image for an identical shooting object, wherein a first shooting apparatus capturing the first image and a second shooting apparatus capturing the second image are coaxially arranged; correcting the second image according to a shooting parameter of the first shooting apparatus and a shooting parameter of the second shooting apparatus, to obtain a second rectified image corresponding to the second image, wherein a parallax between the second rectified image and the first image in a vertical direction or a horizontal direction is zero.

Optionally, correcting the second image according to the shooting parameter of the first shooting apparatus and the shooting parameter of the second shooting apparatus to obtain the second rectified image corresponding to the second image, comprises: correcting the second image according to an internal parameter of the first shooting apparatus, and an internal parameter and a rotation matrix of the second shooting apparatus, to obtain the second rectified image corresponding to the second image.

Optionally, correcting the second image according to the internal parameter of the first shooting apparatus and the internal parameter and the rotation matrix of the second shooting apparatus to obtain the second rectified image corresponding to the second image, comprises: the second rectified image is obtained by a following formula: Un=K_{L}·R⁻¹·K⁻¹_{R}·U₀, where U₀ is the second image, Un is the second rectified image, K_{L} is the internal parameter of the first shooting apparatus, R is the rotation matrix of the second shooting apparatus, R⁻¹ is an inverse matrix of the rotation matrix of the second shooting apparatus, K_{R} is the internal parameter of the second shooting apparatus, K⁻¹_{R} is an inverse matrix of an internal parameter matrix of the second shooting apparatus.

Optionally, before correcting the second image according to the shooting parameter of the first shooting apparatus and the shooting parameter of the second shooting apparatus, the method further comprises: adjusting the shooting parameter of the second shooting apparatus based on a preset parameter change range and an objective function that is preset.

Optionally, adjusting the shooting parameter of the second shooting apparatus based on the preset parameter change range and the objective function that is preset, comprises: extracting a pixel pair from the first image and the second image, wherein the pixel pair comprises a first pixel in the first image and a second pixel in the second image, and the first pixel and the second pixel correspond to an identical world coordinate; setting the objective function to make an ordinate difference or an abscissa difference between the first pixel and a rectification point of the second pixel be the smallest, wherein the rectification point of the second pixel is obtained by following modes: correcting the second pixel according to the shooting parameter of the first shooting apparatus and an adjusted shooting parameter of the second shooting apparatus, to obtain the rectification point of the second pixel; adjusting the shooting parameter of the second shooting apparatus based on the objective function and the preset parameter change range.

Optionally, setting the objective function to make the ordinate difference or the abscissa difference between the first pixel and a rectification point of the second pixel be the smallest, comprises: in a case where a plurality of pixel pairs are provided, for each pixel pair of the plurality of pixel pairs, calculating an ordinate difference or an abscissa difference between a first pixel and a rectification point of a second pixel and in the pixel pair; setting the objective function, to make a sum of ordinate differences or abscissa differences corresponding to the plurality of pixel pairs be the smallest.

Optionally, adjusting the shooting parameter of the second shooting apparatus based on the objective function and the preset parameter change range, comprises: performing following operations based on the objective function: adjusting a rotation angle of the second shooting apparatus within a preset change range of a rotation angle of the second shooting apparatus, and determining a rotation matrix of the second shooting apparatus that has adjusted according to an adjusted rotation angle of the second shooting apparatus; adjusting a focal length in the internal parameter of the second shooting apparatus within a preset change range of the focal length in the internal parameter of the second shooting apparatus; adjusting a position of a main point in the internal parameter of the second shooting apparatus within a preset change range of the position of the main point in the internal parameter of the second shooting apparatus, wherein the main point is an intersection of an optical axis of the second shooting apparatus and a plane of the second image.

The embodiment of the present application provides an image rectification apparatus, the apparatus includes: an acquisition module, configured to obtain a first image and a second image for an identical shooting object, wherein a first shooting apparatus collecting the first image and a second shooting apparatus collecting the second image are coaxially arranged; and a rectification module, configured to correct the second image according to a shooting parameter of the first shooting apparatus and a shooting parameter of the second shooting apparatus to obtain a second rectified image corresponding to the second image, wherein a parallax between the second rectified image and the first image in a vertical direction or a horizontal direction is zero.

The embodiment of the present application provides an electronic system, the electronic system includes: a processing device and a storage apparatus; a computer program is stored on the storage apparatus, and the computer program executes the image rectification method according to the first aspect in a case where the computer program executed by the processing device.

The embodiment of the present application provides a computer-readable storage medium, a computer program is stored on the computer-readable storage medium, in a case where the computer program is run by processing device, the computer program executes steps of the image rectification method according to the first aspect.

The embodiment of the present application provides an image rectification method, a rectification apparatus and an electronic system. The image rectification method includes: acquiring a first image and a second image for the same shooting object through a first shooting apparatus and a second shooting apparatus which are coaxially arranged; according to the shooting parameters of the first shooting apparatus and the second shooting apparatus, obtaining a second rectified image corresponding to the second image, so as to make a parallax between the second rectified image and the first image in the vertical direction or horizontal direction is zero. In this way, only the second image is corrected by adjusting the shooting parameters of the first shooting apparatus and the second shooting apparatus based on the first image, which improves the operation efficiency of image rectification and the accuracy and stability of image correction results.

### BRIEF DESCRIPTION OF THE DRAWINGS

In order to clearly illustrate the technical solutions of the embodiments of the present disclosure, the drawings of the embodiments will be briefly described in the following; it is obvious that the described drawings are only related to some embodiments of the present disclosure and thus are not limitative to the present disclosure.

FIG. 1 is a structural diagram of an image stereo rectification provided by an embodiment of the present application;

FIG. 2 is a simple model of the image stereo rectification provided by an embodiment of the present application;

FIG. 3 is a structural diagram of an electronic system provided by an embodiment of the present application;

FIG. 4 is a flow chart of the image rectification method provided by an embodiment of the present application;

FIG. 5 is a flow chart of another image rectification method provided by an embodiment of the present application;

FIG. 6 is a structural diagram of a shooting apparatus in the same horizontal direction provided by an embodiment of the present application;

FIG. 7 is a schematic diagram of an image before performing the image rectification provided by an embodiment of the present application;

FIG. 8 is a schematic diagram of an image after performing the image rectification provided by an embodiment of the present application;

FIG. 9 is a flow chart of another image rectification method provided by an embodiment of the present application;

FIG. 10 is a flow chart of a method for adjusting shooting parameters provided by an embodiment of the present application;

FIG. 11 is a structural diagram of an image rectification apparatus provided by an embodiment of the present application.

### DETAILED DESCRIPTION

The technical solution of the application will be clearly and completely described below in combination with the embodiments. Obviously, the described embodiments are part of the embodiments of the application, not all of them. Based on the embodiments in the application, all other embodiments obtained by those skilled in the art without making creative work fall within the protection scope of the application.

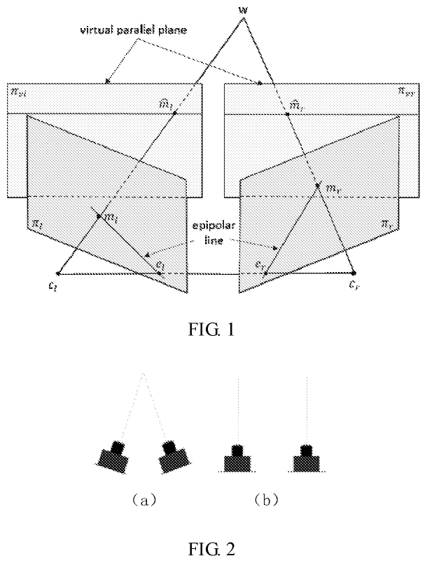

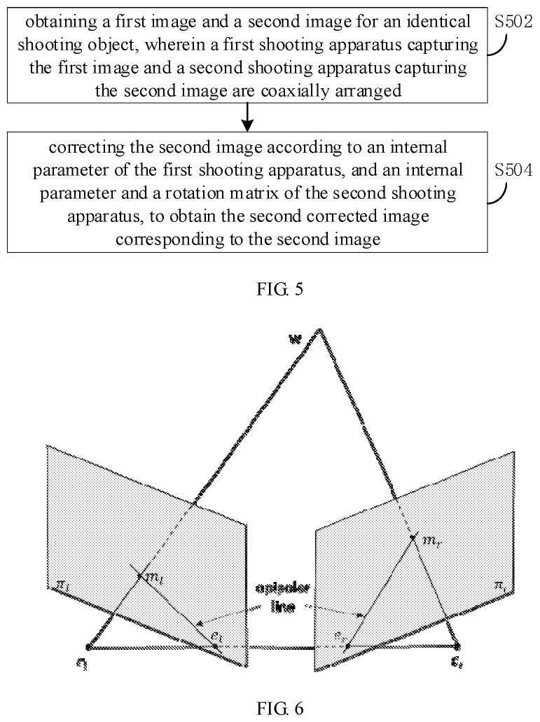

In related technologies, image stereo rectification may reduce the stereo matching search from two dimensions to one dimension, that is, the image satisfies a row alignment constraint. In practical applications, absolute row alignment may not be achieved either for the processing accuracy of a camera or for the installation requirement of a module. Therefore, it is necessary to realize the row alignment of the image collected by two cameras through an algorithm. For example, as the schematic diagram of image stereo rectification shown in FIG. 1, where cl and cr are optical centers of left and right shooting apparatuses respectively, πl and πr are the images captured by the left and right shooting apparatuses respectively, w is a point in a three-dimensional space. After a perspective projection, ml and mr are image points in the images captured by the left and right shooting apparatuses respectively, and el and er are intersections of optical center connecting lines of the left and right shooting apparatuses and the left and right images respectively, the intersection may also be called epipolar (or epipolar point); the connecting line between ml and el and the connecting line between mr and er may be called epipolar line, corresponding to the “epipolar line” as shown in FIG. 1 and FIG. 6. After the image stereo rectification, the two images π1 and nr are transformed into two new virtual images πvl and πvr respectively, corresponding to the “virtual parallel plane” shown in FIG. 1; at this time, the image coordinate of the three-dimensional space point w in the virtual image of the left shooting apparatus is \hat{m}ₗ, and the image coordinate in the virtual image of the right shooting apparatus is \hat{m}ᵣ. After the image stereo rectification, the ordinates of \hat{m}ₗ and \hat{m}ᵣ are the same, so as to complete the image stereo rectification.

The above image rectification process may be based on the same three-dimensional space, changing attitudes of the original shooting apparatuses according to a certain relationship, so that the two newly obtained shooting apparatuses are at a fixed base distance and with the same attitude. Therefore, the stereo rectification model shown in FIG. 1 may be simplified to a simple model of image stereo rectification shown in FIG. 2. Part (a) of FIG. 2 is original positions of the left and right shooting apparatuses. After the image stereo rectification, referring to part (b) of FIG. 2, the left and right shooting apparatuses are at the same horizontal position with the same attitude, and optical axes of the left and right shooting apparatuses are parallel. In related technologies, many algorithms may be used for image rectification. For example, a cylindrical projection algorithm may project an image onto a common cylindrical surface to get corrected image, but the calculation of the cylindrical projection algorithm is complex. For another example, the image rectification process may be divided into two parts: projective transformation and affine transformation, however, the projective transformation needs nonlinear solution, which may not guarantee the stability of image rectification.

In addition, in the application of a mobile phone with dual-cameras or multi-cameras, the multi-camera module of mobile phone can achieve high accuracy after calibration in the module factory, but it is not ideal after installation on the mobile phone. On the one hand, due to the pressure of mobile phone installation or external factors, the locations of the dual-cameras or the multi-cameras have changed; on the other hand, the cameras of the mobile phone adopt focusing lens, when clicking on the mobile phone screen at different positions, these positions may correspond to different focal lengths, and if the original calibration data is still used to process, the accuracy of the rectification results will eventually be reduced.

Based on this, the embodiment of the present application provides an image rectification method, an apparatus and an electronic system. The technology may be applied to security device, computer, mobile phone, camera, tablet computer, vehicle terminal device and other devices with shooting apparatuses. The technology may be implemented by software and hardware. The embodiments will be described in follow.

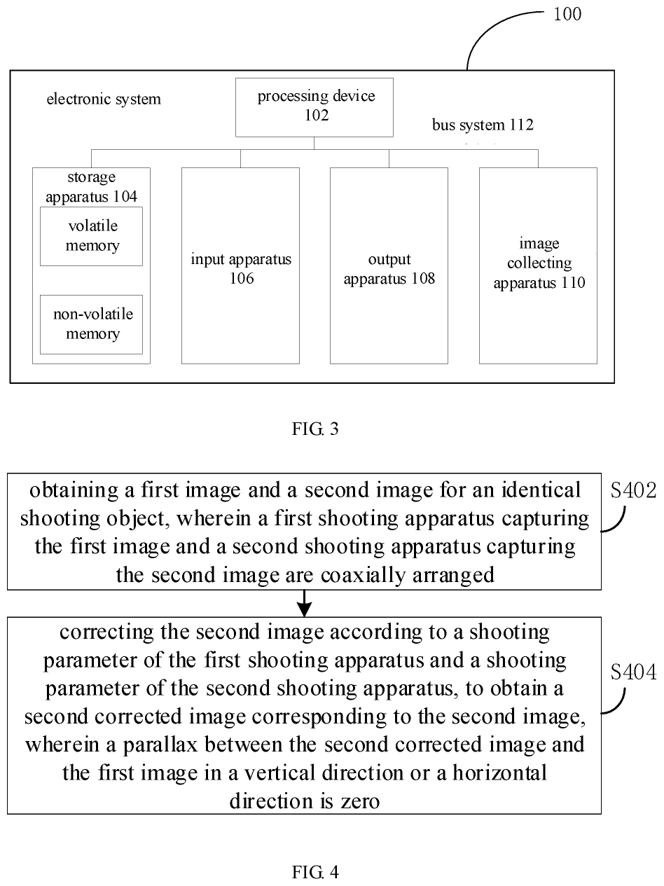

Referring to FIG. 3, the embodiment of the present application provides an exemplary electronic system 100 for implementing the image rectification method, the apparatus, and the electronic system provided by the embodiments of the present application.

As shown in FIG. 3, the electronic system 100 includes one or more processing devices 102, one or more storage apparatuses 104, an input apparatus 106, an output apparatus 108, and an image collecting apparatus 110. These components are interconnected through a bus system 112 and/or other forms of connection mechanisms (not shown). It should be noted that the components and structures of the electronic system 100 as shown in FIG. 3 are only exemplary and not restrictive, and the electronic system may also have other components and structures as required.

The processing device 102 may be a network gate, or an smart terminal, or a central processing unit (CPU) or a device of other forms of processing unit with data processing capability and/or instruction executing capability. The processing device 102 may process data of other components in the electronic device 100 and may also control other components in the electronic device 100 to perform desired functions.

The storage apparatus 104 may include one or more computer program products, which may include various forms of computer-readable storage media, such as volatile memory and/or non-volatile memory. The volatile memory may include, for example, random access memory (RAM) and/or cache, or the like. The non-volatile memory may include, for example, read only memory (ROM), hard disk, flash memory, and the like. One or more computer program instructions may be stored on the computer-readable storage medium, and the processing device 102 may execute the program instructions to implement the client functions and/or other desired functions (implemented by the processing device) in the embodiments of the present application described below. Various application programs and various data, such as various data used and/or generated by the application program, etc., may also be stored in the computer-readable storage medium.

The input apparatus 106 may be an apparatus used by a user to input instructions, and may include one or more of the keyboard, mouse, microphone, touch screen, and the like.

The output apparatus 108 may output various information (e.g., image, sound) to the outside (e.g., a user), and may include one or more of the display, speaker, and the like.

The image collecting apparatus 110 may capture user-desired image (e.g., image to be corrected or identified, etc.) and store the captured image or video frame in the storage apparatus 104 for use by other components.

Exemplarily, each device in the exemplary electronic system for implementing the image rectification method, apparatus, and electronic system according to the embodiments of the present application may be set in an integrated mode, or may be set in a decentralized mode, for example, the processing device 102, the storage apparatus 104, the input apparatus 106, the output apparatus 108 and the image collecting apparatus 110 are integrated into one electronic device, and the image acquisition apparatus 110 is set at a designated position where images may be captured. When the various devices in the above-mentioned electronic system are integrated, the electronic system may be implemented as a smart terminal such as a camera, smart phone, tablet computer, computer, vehicle-mounted terminal, vidicon, or the like.

At least one embodiment of the present application provides an image rectification method. As shown in FIG. 4, the method includes the following steps:

Step S402, obtaining a first image and a second image for an identical shooting object, for example, a first shooting apparatus capturing the first image and a second shooting apparatus capturing the second image are coaxially arranged.

The first image and the second image for the same shooting object may be original images captured by the shooting apparatuses for the same object. For example, the first image may be captured by the first shooting apparatus and the second image may be captured by the second shooting apparatus, and the center points of the first image and the second image may be on the same horizontal line. For example, the contents of the first image and the second image may be the same, that is, the first image and the second image contain the same shooting object, and the shooting object may be a person, an object, and/or a landscape, etc. However, because the shooting lens of the first shooting apparatus and the second shooting apparatus may cover different shooting target ranges, the field angle of the first image and the second image are different. For example, the field angle of the first image is small, and the field angle of the second image is large, so that the first image and the second image are not in the same horizontal direction or vertical direction. The first shooting apparatus and the second shooting apparatus are in the same horizontal direction or vertical direction, that is, the first shooting apparatus and second shooting apparatus are coaxially arranged.

In step S404, correcting the second image according to a shooting parameter of the first shooting apparatus and a shooting parameter of the second shooting apparatus, to obtain a second rectified image corresponding to the second image, and a parallax between the second rectified image and the first image in a vertical direction or a horizontal direction is zero.

The shooting parameter(s) may include internal parameter(s) and external parameter(s). For example, the internal parameter is determined by the shooting apparatus itself and only related to the shooting apparatus itself. The internal parameter may include: parameter matrix, distortion coefficient, etc. The external parameter is determined by a relative pose relationship between the shooting apparatus and the world coordinate system. The external parameter may include: rotation vector and translation vector. Specifically, a correction model may be built according to the shooting parameters of the first shooting apparatus and the second shooting apparatus, dynamically correcting the parameters that may change in the model according to the corrected parameters to obtain a second rectified image corresponding to the second image, and making the parallax between the second rectified image and the first image in a vertical direction or a horizontal direction to be zero. For example, in the same three-dimensional spatial coordinates, the second rectified image and the first image only have difference in the horizontal direction, and the ordinates are consistent; or the second rectified image and the first image only have difference in the vertical direction, and the abscissas are consistent.

The image rectification method provided by the embodiment of the present application, obtaining a first image and a second image for an identical shooting object by the first shooting apparatus and the second shooting apparatus that are arranged coaxially; according to the shooting parameters of the first shooting apparatus and the second shooting apparatus, correcting the second image to obtain the second rectified image corresponding to the second image, and making the parallax between the second rectified image and the first image in the vertical direction or horizontal direction to be zero. In this method, the first image is taken as the standard, and only the second image is corrected through the shooting parameters of the first shooting apparatus and the second shooting apparatus, which improves the operation efficiency of image rectification and improves the accuracy and stability of image rectification results.

The embodiments of the present application also provide another image rectification method, which is implemented on the basis of the above method. The specific implementation process (realized through step S504) of the step of correcting the second image to obtain the second rectified image corresponding to the second image according to the shooting parameters of the first shooting apparatus and the second shooting apparatus is described. As shown in FIG. 5, the method includes the following steps:

Step S502, obtaining a first image and a second image for an identical shooting object, wherein a first shooting apparatus capturing the first image and a second shooting apparatus capturing the second image are coaxially arranged.

Step S504, correcting the second image according to an internal parameter of the first shooting apparatus, and an internal parameter and a rotation matrix of the second shooting apparatus, to obtain the second rectified image corresponding to the second image.

The internal parameters of the first shooting apparatus and the second shooting apparatus may be 3×3 matrix, and the rotation matrix of the second shooting apparatus may also be 3×3 matrix. In practice, an optimization algorithm, such as Levenberg-Marquardt algorithm, etc., may be used to set an objective function to optimize the internal parameter of the first shooting apparatus, the internal parameter and the rotation matrix of the second shooting apparatus, so as to obtain the corrected internal parameter and rotation matrix of the second shooting apparatus, and using the corrected internal parameter and rotation matrix of the second shooting apparatus and the internal parameter of the first shooting apparatus, correcting the second image by rotation and translation; or, the corrected internal parameter and rotation matrix of the second shooting apparatus and the internal parameter of the first shooting apparatus are substituted into the pre-constructed rectification model to correct the second image and obtain the second rectified image corresponding to the second image.

For the above second rectified image, Un=K_{L}·R⁻¹·K⁻¹_{R}·U₀, where U₀ is the second image; Uₙ is the second rectified image; K_{L} is the internal parameter of the first shooting apparatus; R is the rotation matrix of the second shooting apparatus; R⁻¹ is an inverse matrix of the rotation matrix of the second shooting apparatus; K_{R} is the internal parameter of the second shooting apparatus; K⁻¹_{R} is an inverse matrix of the internal parameter matrix of the second shooting apparatus.

The above second rectified image Uₙ=K_{L}·R⁻¹·K⁻¹_{R}·U₀ may be derived in the following way:

in the imaging model of the shooting apparatus, the perspective projection matrix P may be used to represent the shooting apparatus model:

P=K[R T] (1)

In the above formula, R is a rotation matrix of a monocular shooting apparatus; T is a translation vector of the monocular shooting apparatus; K is the internal parameters of the monocular shooting apparatus. The rotation matrix R and the translation vector T jointly describe how to convert a point from the world coordinate system into the shooting apparatus coordinate system, the rotation matrix describes the direction of the coordinate axis in the world coordinate system relative to the coordinate axis in the shooting apparatus coordinate system, and the translation vector describes position of a space origin in the hooting apparatus coordinate system.

K is a 3×3 matrix, R is a 3×3 matrix, T is a 3×1 matrix, through equation (1), it is obtained that:

$$P = [ \begin{matrix}{m}_{1}^{T} & {m}_{14} \\ {m}_{2}^{T} & {m}_{24} \\ {m}_{3}^{T} & {m}_{34}\end{matrix} ] = [ {P}_{a} \vert p ] \qquad ( 2 )$$

In equation (2), P₀K×R and is a 3×3 matrix, p=K×T and is a 3×1 column vector.

Then the pixel coordinates (u, v) of any point in the image and the world coordinate w corresponding to the any point may be expressed as:

$$\{ \begin{matrix}u = \frac{{m}_{1}^{T} w + {m}_{14}}{{m}_{3}^{T} w + {m}_{34}} \\ v = \frac{{m}_{2}^{T} w + {m}_{24}}{{m}_{3}^{T} w + {m}_{34}}\end{matrix} \qquad ( 3 )$$

In formula (3), when the denominator is m₃^{T}w+m₃₄=0, representing a focal plane. When plane m₁^{T}w+m₁₄=0, the intersecting line between the plane and the image plane is the vertical axis of the image plane. When plane m₂^{T}w+m₂₄=0, the intersecting line between the plane and the image plane is the horizontal axis of the image plane. For example, for the focal plane, the first plane whose intersecting line between the first plane and the image plane is the vertical axis, and the second plane whose intersecting line between the second plane and the image plane is the horizontal axis, the intersection of theses three planes is the optical center coordinate C, that is:

$$P [ \begin{matrix}C \\ 1\end{matrix} ] = 0 \qquad ( 4 )$$

Substituting the above formula P=[P₀|p] into the formula (4) may obtain C=−P₀⁻¹p;

According to C=−P₀⁻¹p and P=[P₀|p], P=[Pₒ|−PₒC] may be obtained;

Substituting the spatial imaging relation U=Pw into P=[Pₒ|−PₒC], it may be obtained that w=C+λPₒ⁻¹U. The equation w=C+λPₒ⁻¹U describes a corresponding relationship between each world coordinate w and each pixel coordinate in the image.

The above transformation process may be expressed as:

C=−Pₒ⁻¹p⇒P=[Pₒ|−PₒC]⇒w=C+λPₒ⁻¹U (5)

In equation (5), λ Is a scale factor, indicating that the world coordinate corresponding to the same pixel coordinate is on one ray, which may be understood as that the connecting line between any pixel on the image and the optical center may form a ray, and any point on the ray may fall on the pixel after imaging; U is a homogeneous coordinate of the image point.

Specifically, it is known that the first shooting apparatus and the second shooting apparatus are calibrated to obtain the projection matrixes P_{oL} and P_{oR}, and the two shooting apparatuses are rotated around their own optical centers until the focal planes of the two shooting apparatuses are coplanar, so as to obtain two new shooting apparatuses; at this time, the projection matrixes are P_{nL} and P_{nR}, the baseline C_{L}C_{R} is included in the focal plane of the first shooting apparatus and the second shooting apparatus, all the polar lines are parallel to each other, and a new x-axis is established in the focal plane so that the x-axis is parallel to the baseline C_{L}C_{R}, so that all the polar lines become horizontal. Therefore, the internal parameters of the first shooting apparatus and the second shooting apparatus after performing image stereo rectification are the same, and the image planes are coplanar and parallel to the baseline.

In combination with the derivation process of the above formula (5), the new projection matrix P_{nL} and P_{nR} are decomposed as:

P_{nL}=A[R|−RC_{L}]

P_{nR}=A[R|−RC_{R}] (6)

In equation (6), A is the internal parameters of the two shooting apparatuses; C_{L} is the optical center of the first shooting apparatus; C_{R} is the optical center of the second shooting apparatus; C_{L} and C_{R} may be calculated by equation (4), and the rotation matrix R may be calculated by the following equation:

$$R = [ \begin{matrix}{r}_{1}^{T} \\ {r}_{2}^{T} \\ {r}_{3}^{T}\end{matrix} ] \qquad ( 7 )$$

In equation (7), r₁, r₂ and r₃ respectively represent x-axis, y-axis and z-axis in the new coordinate system of the corrected shooting apparatus. r₁, r₂ and r₃ may be obtained by the following methods:

The x-axis of the new coordinate system is parallel to the baseline:

$${r}_{1} = \frac{{C}_{L} - {C}_{R}}{‖ {C}_{L} - {C}_{R} ‖} \qquad ( 8 )$$

The y-axis of the new coordinate system is perpendicular to the x-axis of the new coordinate system, and perpendicular to the plane composed of the x-axis of the new coordinate system and the z-axis of the original coordinate system:

r₂=k∧r₁ (9)

In equation (9), k represents a unit vector in the z-axis direction of the original coordinate system.

The z-axis of the new coordinate system is perpendicular to the plane composed of the x-axis of the new coordinate system and the y-axis of the new coordinate system:

r₃=r₁∧r₂ (10)

The spatial imaging relationship between the first shooting apparatus and the second shooting apparatus after image stereo rectification may be expressed as:

sUₙ=Pₙw (11)

In equation (11), s is a scale factor; according to equations (5) and (6), it is obtained that:

$$\{ \begin{matrix}w = {C}_{L} + {λ}_{0} {P}_{0}^{- 1} {U}_{0} \\ w = {C}_{L} + {λ}_{n} {P}_{n}^{- 1} {U}_{n}\end{matrix} ⇒ {U}_{n} = λ {P}_{n} {P}_{0}^{- 1} {U}_{0} \qquad ( 12 )$$

In equation (12), the parameters with subscript label 0 represent parameter, projection matrix and image coordinate before the rectification. The parameters with subscript label n represent the corrected parameter, corrected projection matrix and corrected image coordinate. According to equation (12), the transformation relationship between the corrected image and the original image may be obtained.

Specifically, according to equation (12), the relationship between the images before and after rectification is related to the projection matrix. Assuming that before rectification, the internal parameter of the first shooting apparatus is K_{L}, the external parameter rotation matrix of the first shooting apparatus is R_{L}, the external parameter translation matrix of the first shooting apparatus is T_{L}, and the coordinate of the first image is U_{L}; and before rectification, the internal parameter of the second shooting apparatus is K_{R}, the external parameter rotation matrix of the second shooting apparatus is R_{R}, the external parameter translation matrix of the second shooting apparatus is T_{R}, and the coordinate of the second image is U_{R}. Assuming that after rectification, the internal parameter of the first shooting apparatus is K_{nL}, the external parameter rotation matrix of the first shooting apparatus is R_{nL}, the external parameter translation matrix of the first shooting apparatus is T_{nL}, and the coordinate of the first image is U_{nL}; and after correction, the internal parameter of the second shooting apparatus is K_{nR}, the external parameter rotation matrix of the second shooting apparatus is R_{nR}, the external parameter translation matrix of the second shooting apparatus is T_{nR}, and the coordinate of the second image is U_{nR}. Therefore, equation (12) may be transformed into:

$${U}_{n} = λ {P}_{n} {P}_{0}^{- 1} {U}_{0} ⇒ \{ \begin{matrix}{U}_{nL} = λ {P}_{nL} {P}_{L}^{- 1} {U}_{L} \\ {U}_{nR} = λ {P}_{nR} {P}_{R}^{- 1} {U}_{R}\end{matrix} ⇒ \{ \begin{matrix}{U}_{nL} = {λ [ \begin{matrix}{K}_{nL} & {R}_{nL} & {T}_{nL}\end{matrix} ] [ \begin{matrix}{K}_{L} & {R}_{L} & {T}_{L}\end{matrix} ]}^{- 1} {U}_{L} \\ {U}_{nR} = {λ [ \begin{matrix}{K}_{nR} & {R}_{nR} & {T}_{nR}\end{matrix} ] [ \begin{matrix}{K}_{R} & {R}_{R} & {T}_{R}\end{matrix} ]}^{- 1} {U}_{R}\end{matrix} \qquad ( 13 )$$

Because it can be referenced by the first shooting apparatus may be taken as a reference and kept stationary, K_{nL}=T_{L}, T_{nR}=T_{R} may be obtained by expanding the above equation (13):

$$\{ \begin{matrix}{U}_{nL} = λ \cdot {K}_{nL} \cdot {R}_{nL} \cdot {R}_{L}^{- 1} \cdot {R}_{L}^{- 1} \cdot {U}_{L} \\ {U}_{nR} = λ \cdot {K}_{nR} \cdot {R}_{nR} \cdot {R}_{R}^{- 1} \cdot {K}_{R}^{- 1} \cdot {U}_{R}\end{matrix} \qquad ( 14 )$$

According to the characteristics that the corrected first image and the second image are coplanar and have consistent scale, the parameters of the first shooting apparatus and the second shooting apparatus after rectification have the following relationship:

K_{nL}=K_{nR}=Kₙ

R_{nL}=R_{nR}=eye(3,3)

where eye (3, 3) is a 3×3 unit matrix.

Because λ is the scale factor representing the change relationship of the focal length, so it may be omitted, and equation (14) may be simplified as:

$$\{ \begin{matrix}{U}_{nL} = {K}_{n} \cdot {R}_{L}^{- 1} \cdot {K}_{L}^{- 1} \cdot {U}_{L} \\ {U}_{nR} = {K}_{n} \cdot {R}_{R}^{- 1} \cdot {K}_{R}^{- 1} \cdot {U}_{R}\end{matrix} \qquad ( 15 )$$

Referring to the structural diagram of the shooting apparatus in the same horizontal direction as shown in FIG. 6, where C_{L} is the optical center of the first shooting apparatus and C_{R} is the optical center of the second shooting apparatus; π_{L} is a plane of the first image acquired by the first shooting apparatus, and π_{R} is a plane of the second image acquired by the second shooting apparatus. At this time, the image stereo rectification model may be further simplified. For example, it is possible to keep the first shooting apparatus stationary and only move the second shooting apparatus based on the first shooting apparatus, and finally the optical axes of the two shooting apparatuses are parallel, and the first image and the second image are coplanar, so that the corrected two shooting apparatuses have a fixed base distance while maintaining the same posture.

Specifically, through the above method for image rectification, because the first shooting apparatus remains stationary, the internal parameters of the first shooting apparatus before and after correction also remain unchanged, and the rotation matrix of the first shooting apparatus is the unit matrix, so that the first shooting apparatus remains stationary after rectification, the following objective function may be obtained:

Kₙ=K_{L}

R_{L}=eye(3,3)

R_{R}=R

where R is the rotation matrix of the second shooting apparatus;

According to the above objective function, the stereo rectification model that meets the conditions may be derived:

$$\{ \begin{matrix}{U}_{nL} = {K}_{L} \cdot {R}_{L}^{- 1} \cdot {U}_{L} = {U}_{L} \\ {U}_{nR} = {K}_{L} \cdot {R}^{- 1} \cdot {K}_{R}^{- 1} \cdot {U}_{R}\end{matrix} \qquad ( 16 )$$

According to equation (16), the second rectified image may finally be obtained:

Uₙ=K_{L}·R⁻¹·K_{R}⁻¹·U₀ (17)

In equation (17), Uₙ corresponds to U_{nR} in equation (16), and U₀ corresponds to U_{R} in equation (16).

Specifically, according to equation (17), the first shooting apparatus and the second shooting apparatus that have been calibrated successfully may be obtained. Because the first shooting apparatus is usually a zoom camera, the focal lengths of image pairs taken each time by the first shooting apparatus and the second shooting apparatus may be inconsistent; or after the shooting apparatuses are calibrated successfully, the dual-camera structure may change due to compression, collision, falling and so on during installation; or after the installation, in the process of use, due to problems such as collision and aging, the dual-camera structure will also change. The above zoom may cause the change of internal parameters, and the change of dual-camera structure may cause the change of rotation matrix. Therefore, the variables included in the internal parameters and rotation matrix of the shooting apparatus may be written as:

$$\prod ( α , β , γ , s , u , v ) = {K}_{L} \cdot {[ \begin{matrix}α \\ β \\ γ\end{matrix} ]}_{R}^{- 1} \cdot [ \begin{matrix}s \cdot {f}_{x} & 0 & u \\ 0 & s \cdot {f}_{y} & v \\ 0 & 0 & 1\end{matrix} ] \qquad ( 18 )$$

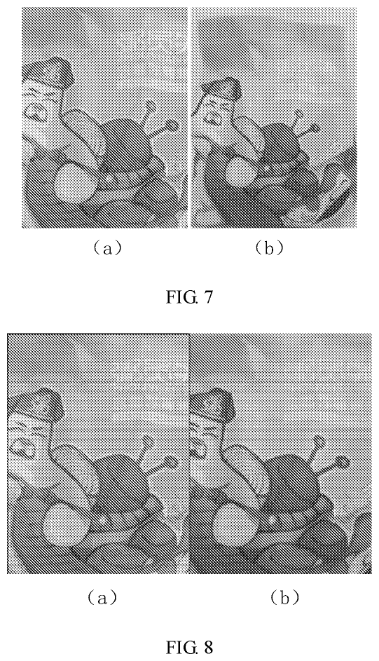

Therefore, in the actual image rectification process, parameters K_{L}, R and K_{R} may be dynamically adjusted, and the adjusted parameters K_{L}, R and K_{R} may be substituted into equation (17) to obtain the second rectified image. For example, referring to the image schematic diagrams before and after rectification shown in FIG. 7 and FIG. 8, where part (a) of FIG. 7 and part (a) of FIG. 8 are the first image, part (b) of FIG. 7 is the second image, and part (b) of FIG. 8 is the second rectified image. Finally, the second rectified image is aligned with the first image in the row direction, and the horizontal parallax is zero.

In this method, taking the first shooting apparatus as the reference, and keeping the first shooting apparatus to be stationary, only moving the second shooting apparatus. Through this method, setting the objective function to obtain a simplified image rectification model. Through the image rectification model, the first image captured by the first shooting apparatus and the second image captured by the second shooting apparatus may be coplanar, and the corrected first shooting apparatus and the corrected second shooting apparatus have the fixed base distance and keep the same posture at the same time. Compared with the Fusiello (epipolar correction) algorithm model, the model obtained by the algorithm of the embodiment of the present application is not only simple, but also improves the operation efficiency, and improves the accuracy and stability of the rectification results.

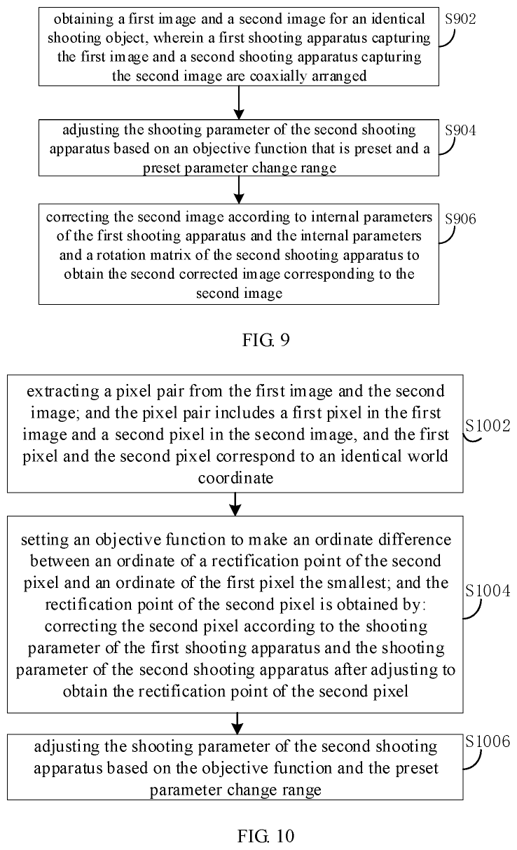

The embodiment of the present application also provides a flowchart of another image rectification method, and the method may be implemented on the basis of the above embodiment. Here, the specific steps before the step of correcting the second image according to the shooting parameters of the first shooting apparatus and the second shooting apparatus are mainly described. As shown in FIG. 9, the method includes the following steps:

Step S902, obtaining a first image and a second image for an identical shooting object, wherein a first shooting apparatus capturing the first image and a second shooting apparatus capturing the second image are coaxially arranged;

Step S904: adjusting the shooting parameter of the second shooting apparatus based on a preset objective function and a preset parameter change range.

The above-mentioned preset objective function usually refers to the pursued objective form expressed by design variables, so the objective function is the function of design variables. In the embodiment of the present application, the objective function is a result of the final rectification, for example, the parallax between the first image and the second image in the horizontal direction or vertical direction is zero, the ordinate of the same pixel in the image coordinates of the corresponding first image and second image is aligned, and the ordinate error of the same pixel is the smallest; it may also be that the horizontal ordinate of the same pixel in the image coordinates of the corresponding first image and second image is aligned, and the horizontal ordinate error of the same pixel is the smallest.

Because the shooting parameter of the second shooting apparatus to be adjusted usually changes around an initial value, the preset parameter change range may be limited according to actual initial positions of the first shooting apparatus and second shooting apparatus for the parameter to be adjusted. The preset parameter may include the rotation matrix R of the second shooting apparatus, the internal parameter K_{R} of the second shooting apparatus, the internal parameter K_{L} of the second shooting apparatus, and the like. For example, a floating value may be set according to the parameter characteristics of an actual shooting apparatus, so that the above-mentioned preset parameter change range may be adjusted between the floating values. Through the preset objective function, the shooting parameters of the second shooting apparatus may be adjusted within the preset parameter change range, so as to make the finally determined adjusted shooting parameters of the second shooting apparatus meet the preset objective function.

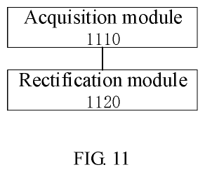

For the above steps of adjusting the shooting parameter of the second shooting apparatus based on the preset objective function and the preset parameter change range, referring to the flowchart of the adjustment method of the shooting parameter shown in FIG. 10, the method includes the following steps:

Step S1002, extracting a pixel pair from the first image and the second image; and the pixel pair includes a first pixel in the first image and a second pixel in the second image, and the first pixel and the second pixel correspond to an identical world coordinate.

The above first pixel and the second pixel may be representative parts of the image. For example, the information of the pixel may include: position coordinate, size, direction and other information. Because the shooting apparatuses may be placed at any position in environment, a reference coordinate system may be selected to describe the position of the shooting apparatus in the environment, and using the reference coordinate system to describe the position of any object in the environment, the reference coordinate system may be called the world coordinate system. In addition, the relationship between coordinate system of the shooting apparatus and the world coordinate system may be described by a rotation matrix and a translation vector.

Specifically, the first pixel of the first image and the second pixel of the second image may be extracted by pixel extraction methods, such as SIFT (Scale-Invariant Features Transform), SURF (Speed Up Robust Features) and so on. A pixel pair matching the first image and the second image may be obtained by pixel matching methods, such as FLANN (Fast Library for Approximate Nearest Neighbors), SURF (Accelerated Up Robust Features), ORB (Oriented Fast and Rotated Brain, an algorithm for fast pixel extraction and description) and other matching methods. For example, the first pixel of the first image corresponds to the second pixel of the second image, the first pixel and the second pixel may form a pixel pair; finally, reliable pixel pairs among the plurality of pixel pairs may be filtered out by data filtering method.

In step S1004, setting an objective function to make an ordinate difference between an ordinate of a rectification point of the second pixel and an ordinate of the first pixel the smallest; and the rectification point of the second pixel is obtained by: correcting the second pixel according to the shooting parameter of the first shooting apparatus and the shooting parameter of the second shooting apparatus after adjusting to obtain the rectification point of the second pixel.

According to the derivation process of the above equation (17), the image rectification only needs to adjust the parameters of the second image. Therefore, according to the shooting parameter K_{L} of the first shooting apparatus, the inverse matrix R⁻¹ of the rotation matrix and the inverse matrix K_{R}⁻¹ of the internal parameters of the adjusted second shooting apparatus, using the calculation method of formula (17), adjusting the angle and coordinate of the second pixel by means of rotation and translation to obtain the rectification point of the second pixel. In practice, taking the difference between the ordinate of the rectification point of the second pixel in the second image and the ordinate of the first pixel being minimal as the above objective function.

The step of setting the objective function to make the difference between the ordinate of the rectification point of the second pixel and the ordinate of the first pixel be the smallest, includes:

in a case where a plurality of pixel pairs are provided, for each pixel pair of the plurality of pixel pairs, calculating an ordinate difference between an ordinate of a rectification point of the second pixel and an ordinate of the first pixel in the pixel pair; setting the objective function so as to minimize the sum of the ordinate differences corresponding to the plurality of pixel pairs.

In general, the method of extracting pixels may extract a plurality of pixels in the image, which includes a plurality of features of the image, and finally obtaining a plurality of pixel pairs. When the first shooting apparatus and the second shooting apparatus are arranged on the same vertical axis, the parallax between the captured first image and the second image in the horizontal direction is large. Therefore, the shooting parameters of the second shooting apparatus may be adjusted according to the set objective function, and calculating the ordinate difference between the ordinate of the rectification point of the second pixel and the ordinate of the first pixel in each pixel pair, to obtain a plurality of ordinate differences. Adding the ordinate differences to obtain the sum of the ordinate differences. Adjusting the shooting parameters of the second shooting apparatus to make the sum of the ordinate differences minimum, that is, the parallax between the first image and the second image in the horizontal direction is close to zero.

In addition, when the first shooting apparatus and the second shooting apparatus are arranged on the same horizontal axis, the parallax between the acquired first image and the second image in the vertical direction is large. For each pixel pair, calculating the abscissa difference between the abscissa of the rectification point of the second pixel and the abscissa of the first pixel in each pixel pair, setting an objective function to minimize the sum of ordinate differences corresponding to the plurality of pixel pairs; finally, making the parallax between the first image and the second image in the vertical direction to be zero.

In step S1006, adjusting the shooting parameter of the second shooting apparatus based on the objective function and the preset parameter change range.

In the embodiment of the application, during actual implementation, according to the preset parameter change range, the ordinate of the second pixel in the second image may be adjusted by LM (Levenberg-Marquardt) optimization method, and by means of translation and rotation, etc., so that the ordinate difference between the ordinate of the second pixel in the adjusted second image and the ordinate of the first pixel is minimized, and finally the shooting parameters of the second shooting device may be adjusted according to the ordinate of the second pixel in the adjusted second image.

For the above step S1006, the step of adjusting the shooting parameters of the second shooting apparatus based on the objective function and the preset parameter change range includes: performing the following operations based on the objective function:

(1) adjusting the rotation angle of the second shooting apparatus within a preset change range of the rotation angle of the second shooting apparatus; and determining the rotation matrix of the adjusted second shooting apparatus through the adjusted rotation angle.

Because the parameters to be optimized usually change around the initial value, in order to make the optimization results more accurate, the change range of the parameters to be optimized should be limited. The rotation matrix of the second shooting apparatus may be equivalently converted into a rotation angle, and the floating value of the preset change range of the rotation angle of the second shooting apparatus may be set to Tᵣ; the rotation angle of the shooting apparatus may be set according to the coordinate axis of the shooting apparatus, including the rotation angles Rₓ, R_{y} and R_{z} corresponding to the x-axis, y-axis and z-axis respectively. Therefore, for each rotation angle, according to the preset change range, the adjustable ranges are [(Rₓ−Tᵣ), (Rₓ+Tᵣ)], [(R_{y}−Tᵣ), (R_{y}+Tᵣ)], [(R_{z}−Tᵣ), (R_{z}+Tᵣ)]. For example, the rotation angle of the second shooting apparatus around the x-axis is a, and the initial value of α is Rₓ, the change range of a is (Rₓ−Tᵣ) to (Rₓ+Tᵣ); the rotation angle of the second shooting apparatus around the y-axis is and the initial value of is R_{y}, the change range of β is (R_{y}−Tᵣ) to (R_{y}+Tᵣ); the rotation angle of the second shooting apparatus around the z-axis is γ, and the initial value of γ is R_{z}, the change range of γ is (R_{z}−Tᵣ) to (R_{z}+Tᵣ).

Specifically, based on the objective function, the rotation angle of the second shooting apparatus may be adjusted according to the adjustment range of the above each rotation angle; through the equivalent conversion between the rotation angle and the rotation matrix, for example, Rodriguez rotation formula, the adjusted rotation angle of the second shooting apparatus is converted into a rotation matrix, so that the parallax between the first image and the second rectified image in the vertical direction or horizontal direction is zero.

(2) adjusting the focal length in the internal parameters of the second shooting apparatus within a preset change range of the focal length in the internal parameters of the second shooting apparatus.

Because focal length and magnification may be mutually converted, the focal length in the internal parameters of the second shooting apparatus may be expressed by a magnification of the focal length, for example, the magnification of the focal length may be expressed by s. In this embodiment, the initial value of the magnification of the focal length may be set to 1.0. The floating value of the preset change range of the focal length in the internal parameters of the second shooting apparatus may be set to Tₛ. Therefore, the preset change range of the focal length s in the internal parameters of the second shooting apparatus may be [(1.0−Tₛ), (1.0+Tₛ)]; where 1.0 is the initial value of s, and the focal length s varies from 1.0−Tᵣ to 1.0+Tᵣ.

Specifically, based on the objective function, the focal length in the internal parameters of the second shooting apparatus may be adjusted according to the change range of the focal length s, so that the parallax between the first image and the second rectified image in the vertical or horizontal direction is zero.

(3) adjusting a position of a main point in the internal parameters of the second shooting apparatus within a preset change range of the position of the main point in the internal parameters of the second shooting apparatus, where the main point is an intersection of an optical axis of the second shooting apparatus and a plane of the second image.

The position of the main point in the internal parameters of the second shooting apparatus may refer to the coordinate of the intersection of the optical axis of the second shooting apparatus and the second image plane, which may be expressed by (u, v), where u represents the abscissa of the position of the main point and v represents the ordinate of the position of the main point. This embodiment may be illustrated by taking an initial value of the abscissa of the position of the main point as u₀ and an initial value of the ordinate as v₀. The abscissa floating value of the preset change range of the position of the main point in the internal parameters of the second shooting apparatus may be set to Tᵤ, and the ordinate floating value may be set to Tᵥ. Therefore, the preset change range of the abscissa of the position of the main point in the internal parameters of the second shooting apparatus may be[(u₀−Tᵤ), (u₀+Tᵤ)], and the preset change range of the ordinate of the position of the main point may be [(v₀−Tᵥ), (v₀+Tᵥ)]. For example, the abscissa of the position of the main point in the internal parameters of the second shooting apparatus is represented by u of which initial value is u₀, so the change range of the abscissa of the main point is u₀−Tᵤ to u₀+Tᵤ; similarly, the ordinate of the position of the main point in the internal parameters of the second shooting apparatus is represented by v of which initial value is v₀, so the change range of the ordinate of the main point is v₀−Tᵥ to v₀+Tᵥ.

Specifically, based on the objective function, the coordinate of the position of the main point in the internal parameters of the second shooting apparatus may be adjusted according to the preset change range of the position of the main point in the internal parameters of the second shooting apparatus, so as to make the parallax between the first image and the second rectified image in the vertical or horizontal direction be zero.

In addition, optionally, in the embodiment of the present application, the step of adjusting the shooting parameter of the second shooting apparatus based on the preset objective function and the preset parameter change range may include: adjusting the shooting parameter of the second shooting apparatus within the preset parameter change range for the shooting parameter of the second shooting apparatus, to make the preset objective function obtain an optimal solution. In the embodiment of the present application, the optimal solution of the objective function may be interpreted as, for example, the solution of the objective function that enables the shooting parameters of the second shooting apparatus that is expected to be optimized to be adjusted to the current optimal state within the allowable or achievable adjustment range.

Optionally, the step of obtaining the optimal solution of the preset objective function may include: extracting a pixel pair from the first image and the second image based on a world coordinate system, and the pixel pair comprises a first pixel in the first image and a second pixel matching with the first pixel in the second image; when the first shooting apparatus and the second shooting apparatus are arranged on the same horizontal axis, minimizing the abscissa difference between the abscissa of the first pixel and the abscissa of the rectification point of the second pixel (that is, at this time, the optimal solution of the objective function is related to the minimization of the abscissa difference between the first pixel and the rectification point of the second pixel), or, when the first shooting apparatus and the second shooting apparatus are arranged on the same vertical axis, minimizing the ordinate difference between the ordinate of the first pixel and the ordinate of the rectification point of the second pixel (that is, at this time, the optimal solution of the objective function is related to the minimization of the ordinate difference between the rectification point of the second pixel and the first pixel); the above rectification point with respect to the second pixel may be obtained by adjusting the shooting parameters of the second shooting apparatus.

Optionally, in the embodiment of the present application, the step of adjusting the shooting parameters of the second shooting apparatus based on the preset objective function and the preset parameter change range may include: extracting pixel pairs from the first image and the second image based on the world coordinate system, wherein the pixel pairs include the first pixel in the first image and the second pixel matching the first pixel in the second image; obtaining the adjusted shooting parameters of the second shooting apparatus by the following modes: adjusting the shooting parameters of the second shooting apparatus within the preset parameter change range for the shooting parameters of the second shooting apparatus to obtain the rectification point of the second pixel, so that the objective function related to the coordinate difference (e.g., the abscissa difference or ordinate difference) between the rectification point of the second pixel and the first pixel may obtain the optimal solution (e.g., this corresponds to the minimization of the above-mentioned coordinate difference).

Optionally, when the first shooting apparatus and the second shooting apparatus are arranged on the same vertical axis, the optimal solution of the objective function may be related to the minimization of the ordinate difference between the ordinate of the first pixel and the ordinate of the rectification point of the second pixel.

Optionally, when the first shooting apparatus and the second shooting apparatus are arranged on the same horizontal axis, the optimal solution of the objective function may be related to the minimization of the abscissa difference between the abscissa of the first pixel and the abscissa of the rectification point of the second pixel.

Optionally, the shooting parameters of the second shooting apparatus that may be adjusted include the inverse matrix R⁻¹ of the rotation matrix of the second shooting apparatus and/or the inverse matrix K_{R}⁻¹ of the internal parameters.

In step S906, correcting the second image according to internal parameters of the first shooting apparatus and the internal parameters and a rotation matrix of the second shooting apparatus to obtain the second rectified image corresponding to the second image.

Specifically, according to the focal length s, the abscissa u and ordinate v of the position of the main point in the adjusted internal parameters of the second shooting apparatus, the corrected internal parameter K_{R} of the second shooting apparatus may be obtained through the above formula (18), and then the rotation matrix R, the internal parameter K_{R} of the corrected second shooting apparatus and the internal parameter K_{L} of the first shooting apparatus may be substituted into the above formula (16) to obtain the transformation matrix H_{L} of the first image and the transformation matrix H_{R} of the second image; where H_{L} is a unit matrix, H_{R}=K_{L}·R⁻¹·K_{R}⁻¹. Using H_{R} to correct the second image U₀ through the above formula (17), calculating Uₙ=H_{R}·U₀, and finally obtaining the second rectified image Uₙ.

In this method, in order to overcome the problem that the image stereo rectification model is inaccurate due to the change of the focal length of the zoom lens and the change of the dual-camera structure, on the basis of knowing the base distance in the horizontal direction of the first shooting apparatus and the second shooting apparatus, texture images of the first image and the second image, the internal parameter matrices of the first shooting apparatus and the second shooting apparatus, and the rotation matrix between the first shooting apparatus and the second shooting apparatus, using the pixel pair extracted from the first image and the second image and the optimization algorithm, optimizing the rotation matrix and internal parameters of the second shooting apparatus which may with the minimum line alignment error as the objective function, so as to obtain the corrected simplified model; according to the simplified model after rectification, the accurate image rectification result is finally obtained, which improves the operation efficiency of image rectification and the accuracy and stability of the image rectification result.

The embodiment of the present application also provides an image rectification apparatus, as shown in FIG. 11. The apparatus includes:

an acquisition module 1110, configured to obtain a first image and a second image for an identical shooting object, wherein a first shooting apparatus collecting the first image and a second shooting apparatus collecting the second image are coaxially arranged;

a rectification module 1120, configured to correct the second image according to a shooting parameter of the first shooting apparatus and a shooting parameter of the second shooting apparatus to obtain a second rectified image corresponding to the second image, where a parallax between the second rectified image and the first image in a vertical direction or a horizontal direction is zero.

Optionally, the rectification module is configured to: correct the second image according to the internal parameter of the first shooting apparatus and the internal parameter and rotation matrix of the second shooting apparatus to obtain the second rectified image corresponding to the second image.

Optionally, the above rectification module includes: the second rectified image Uₙ=K_{L}·R⁻¹·K⁻¹_{R}·U₀; where U₀ is the second image; Uₙ is the second rectified image; K_{L} is the internal parameter of the first shooting apparatus; R is the rotation matrix of the second shooting apparatus; R⁻¹ is the inverse matrix of the rotation matrix of the second shooting apparatus; K_{R} is the internal parameter of the second shooting apparatus; K⁻¹_{R} is the inverse matrix of the internal parameter matrix of the second shooting apparatus.

Optionally, the apparatus also includes a shooting parameter adjustment module configured to adjust the shooting parameter of the second shooting apparatus based on a preset objective function and a preset parameter change range.

Optionally, the shooting parameter adjustment module is configured to: extract a pixel pair from the first image and the second image; wherein the pixel pair include a first pixel in the first image and a second pixel in the second image; the first pixel and the second pixel correspond to the same world coordinate; setting an objective function to minimize the ordinate difference between the ordinate of the rectification point of the second pixel and the ordinate of the first pixel; wherein the rectification point of the second pixel is obtained by the following operations: correcting the second pixel according to the shooting parameter of the first shooting apparatus and the adjusted shooting parameter of the second shooting apparatus to obtain the rectification point of the second pixel; adjusting the shooting parameter of the second shooting apparatus based on the objective function and the preset parameter change range.

Optionally, the shooting parameter adjustment module is configured to: in a case where a plurality of pixel pairs are provided, for each of the plurality of pixel pairs, calculating the ordinate difference between the ordinate of the rectification point of the second pixel in the pixel pair and the ordinate of the first pixel; setting the objective function to make the sum of the ordinate differences corresponding to the plurality of pixel pairs be the smallest.

Optionally, the shooting parameter adjustment module is configured to perform the following operations based on the objective function: adjusting the rotation angle of the second shooting apparatus within the preset change range of the rotation angle of the second shooting apparatus; determining the rotation matrix of the adjusted second shooting apparatus according to the adjusted rotation angle; adjusting the focal length in the internal parameters of the second shooting apparatus within a preset change range of the focal length in the internal parameters of the second shooting apparatus; adjusting the position of a main point in the internal parameters of the second shooting apparatus within a preset change range of position of the main point in the internal parameters of the second shooting apparatus; wherein the main point is the intersection of the optical axis of the second shooting apparatus and a plane of the second image.

The image rectification apparatus provided by the embodiment of the present application obtains the first image and the second image for the same shooting object through the first shooting apparatus and the second shooting apparatus that are arranged coaxially; according to the shooting parameters of the first shooting apparatus and the second shooting apparatus, correcting the second image to obtain the second rectified image corresponding to the second image, to make the parallax between the second rectified image and the first image in the vertical or horizontal direction be zero. In this method, the first image is taken as the reference, and only the second image is corrected through the shooting parameters of the first shooting apparatus and the second shooting apparatus, which improves the operation efficiency of image rectification and improves the accuracy and stability of image rectification results.

The embodiment of the present application provides an electronic system, the electronic system includes an image acquisition device, a processing device and a storage apparatus. The image acquisition device is configured to obtain preview video frames or image data. The computer program is stored on the storage apparatus, and the computer program executes the image rectification method or the steps of the image rectification method when the computer program executed by the processor.

Those skilled in the art can clearly understand that for the convenience and conciseness of the description, the specific working process of the electronic system described above may refer to the corresponding process in the above method embodiments and will not be repeated here.

The embodiment of the present application also provides a computer-readable storage medium, wherein a computer program is stored on the computer-readable storage medium, in a case where the computer program is run by a processor, the computer program executes the image rectification method or steps of the image rectification method.

The computer program product of the image rectification method, apparatus and electronic system provided by the embodiment of the present application includes a computer-readable storage medium storing the program code. The instructions included in the program code may be used to execute the method in the previous method embodiment, which may refer to the corresponding process in the above method embodiments and will not be repeated here.

Those skilled in the art can clearly understand that for the convenience and conciseness of the description, the specific working process of the system and/or device described above may refer to the corresponding process in the above method embodiments and will not be repeated here.

In addition, in the description of the embodiments of this application, unless otherwise specified and limited, the terms “installed”, “connected with” and “connected to” should be understood broadly, for example, they may be fixed, detachable or integrally connected; may be mechanically connected or electrically connected; may be directly connected or indirectly connected through an intermediate medium, or may be the internal communication of two elements. For those of ordinary skill in the art, the specific meanings of the above terms in this application can be understood in specific situations.

If the functions are implemented in the form of software functional units and sold or used as independent products, they can be stored in a computer-readable storage medium. Based on this understanding, the part of the technical solution of this application that essentially contributes to the prior art or the part of this technical solution can be embodied in the form of a software product, which is stored in a storage medium and includes a number of instructions to make a computer device (which can be a personal computer, a server, or a network device, etc.) perform all or part of the steps of the methods described in various embodiments of this application. The aforementioned storage media include: U disk, mobile hard disk, Read-Only Memory (ROM), Random Access Memory (RAM), magnetic disk or optical disk and other media that can store program codes.

In the description of this application, it should be noted that the orientations or positional relationships indicated by the terms “center”, “upper”, “lower”, “left”, “right”, “vertical”, “horizontal”, “inside” and “outside” are based on the orientations or positional relationships shown in the drawings, only for the convenience of describing this application and simplifying the description, and are not indicated or implied. In addition, the terms “first”, “second” and “third” are only used for descriptive purposes and cannot be understood as indicating or implying relative importance.

Finally, it should be noted that the above-mentioned embodiments are only the specific implementation of this application and are used to illustrate the technical scheme of this application, but not to limit it. The scope of protection of this application is not limited to this. Although the application has been explained in detail with reference to the above-mentioned embodiments, it should be understood by those skilled in the art that any person familiar with this technical field can still modify or easily think of changes to the technical scheme described in the above-mentioned embodiments within the technical scope disclosed in this application, or however, these modifications, changes or substitutions do not make the essence of the corresponding technical solutions deviate from the spirit and scope of the technical solutions of the embodiments of this application, and should be covered in the scope of protection of this application. Therefore, the scope of protection of this application should be based on the scope of protection of the claims.

### INDUSTRIAL PRACTICAL APPLICABILITY

According to the image rectification method, apparatus and electronic system provided by the embodiment of the application, only the second image is corrected by adjusting the shooting parameters of the first shooting apparatus and the second shooting apparatus based on the first image, so that the operation efficiency of image rectification is improved, and the accuracy and stability of image rectification results are improved.

1. An image rectification method, comprising:
obtaining a first image and a second image for an identical shooting object, wherein a first shooting apparatus capturing the first image and a second shooting apparatus capturing the second image are coaxially arranged; and
correcting the second image according to a shooting parameter of the first shooting apparatus and a shooting parameter of the second shooting apparatus, to obtain a second rectified image corresponding to the second image, wherein a parallax between the second rectified image and the first image in a vertical direction or a horizontal direction is zero.

2. The method according to claim 1, wherein correcting the second image according to the shooting parameter of the first shooting apparatus and the shooting parameter of the second shooting apparatus to obtain the second rectified image corresponding to the second image, comprises:
correcting the second image according to an internal parameter of the first shooting apparatus, and an internal parameter and a rotation matrix of the second shooting apparatus, to obtain the second rectified image corresponding to the second image.

3. The method according to claim 2, wherein correcting the second image according to the internal parameter of the first shooting apparatus and the internal parameter and the rotation matrix of the second shooting apparatus to obtain the second rectified image corresponding to the second image, comprises:
the second rectified image is obtained by a following formula:
Uₙ=K_{L}·R⁻¹·K⁻¹_{R}·U₀;
wherein U₀ is the second image, Un is the second rectified image, K_{L} is the internal parameter of the first shooting apparatus, R is the rotation matrix of the second shooting apparatus, R⁻¹ is an inverse matrix of the rotation matrix of the second shooting apparatus, K_{R} is the internal parameter of the second shooting apparatus, K⁻¹_{R} is an inverse matrix of an internal parameter matrix of the second shooting apparatus.

4. The method according to claim 1, wherein before correcting the second image according to the shooting parameter of the first shooting apparatus and the shooting parameter of the second shooting apparatus, the method further comprises:
adjusting the shooting parameter of the second shooting apparatus based on a preset parameter change range and an objective function that is preset.

5. The method according to claim 4, wherein adjusting the shooting parameter of the second shooting apparatus based on the preset parameter change range and the objective function that is preset, comprises:
extracting a pixel pair from the first image and the second image, wherein the pixel pair comprises a first pixel in the first image and a second pixel in the second image, and the first pixel and the second pixel correspond to an identical world coordinate;
setting the objective function to make an ordinate difference or an abscissa difference between the first pixel and a rectification point of the second pixel be the smallest, wherein the rectification point of the second pixel is obtained by following modes: correcting the second pixel according to the shooting parameter of the first shooting apparatus and an adjusted shooting parameter of the second shooting apparatus, to obtain the rectification point of the second pixel; and
adjusting the shooting parameter of the second shooting apparatus based on the objective function and the preset parameter change range.

6. The method according to claim 5, wherein setting the objective function to make the ordinate difference or the abscissa difference between the first pixel and a rectification point of the second pixel be the smallest, comprises:
in a case where a plurality of pixel pairs are provided, for each pixel pair of the plurality of pixel pairs, calculating an ordinate difference or an abscissa difference between a first pixel and a rectification point of a second pixel and in the pixel pair;
setting the objective function, to make a sum of ordinate differences or abscissa differences corresponding to the plurality of pixel pairs be the smallest.

7. The method according to claim 5, wherein a plurality of internal parameters are provided, and the internal parameters include a focal length and a position of a main point, adjusting the shooting parameter of the second shooting apparatus based on the objective function and the preset parameter change range, comprises:
performing following operations based on the objective function:
adjusting a rotation angle of the second shooting apparatus within a preset change range of a rotation angle of the second shooting apparatus, and determining a rotation matrix of the second shooting apparatus that has adjusted according to an adjusted rotation angle of the second shooting apparatus;
adjusting the focal length in the plurality of internal parameters of the second shooting apparatus within a preset change range of the focal length in the plurality of internal parameters of the second shooting apparatus;
adjusting the position of the main point in the plurality of internal parameters of the second shooting apparatus within a preset change range of the position of the main point in the plurality of internal parameters of the second shooting apparatus, wherein the main point is an intersection of an optical axis of the second shooting apparatus and a plane of the second image.

8. The method according to claim 4, wherein adjusting the shooting parameter of the second shooting apparatus based on a preset parameter change range and an objective function that is preset, comprises:
adjusting the shooting parameter of the second shooting apparatus within the preset parameter change range of the shooting parameter of the second shooting apparatus, to make the objective function obtain an optimal solution.

9. The method according to claim 8, wherein making the objective function obtain the optimal solution, comprises:
extracting a pixel pair from the first image and the second image based on a world coordinate system, wherein the pixel pair comprises a first pixel in the first image and a second pixel matching with the first pixel in the second image; and
making an ordinate difference or an abscissa difference between the first pixel and a rectification point of the second pixel be the smallest, wherein the rectification point of the second pixel is obtained by adjusting the shooting parameter of the second shooting apparatus.

10. The method according to claim 8, wherein adjusting the shooting parameter of the second shooting apparatus, comprises:
adjusting an inverse matrix R⁻¹ of a rotation matrix and an inverse matrix K⁻¹_{R} of an internal parameter of the second shooting apparatus.

11. An image rectification apparatus, comprising:
an acquisition module, configured to obtain a first image and a second image for an identical shooting object, wherein a first shooting apparatus collecting the first image and a second shooting apparatus collecting the second image are coaxially arranged;
a rectification module, configured to correct the second image according to a shooting parameter of the first shooting apparatus and a shooting parameter of the second shooting apparatus to obtain a second rectified image corresponding to the second image, wherein a parallax between the second rectified image and the first image in a vertical direction or a horizontal direction is zero.

12. An electronic system, comprising a processing device and a storage apparatus;
wherein a computer program is stored on the storage apparatus, and the computer program executes an image rectification method according to in a case where the computer program executed by the processing device,
wherein the image rectification method comprises:
obtaining a first image and a second image for an identical shooting object, wherein a first shooting apparatus capturing the first image and a second shooting apparatus capturing the second image are coaxially arranged; and
correcting the second image according to a shooting parameter of the first shooting apparatus and a shooting parameter of the second shooting apparatus, to obtain a second rectified image corresponding to the second image, wherein a parallax between the second rectified image and the first image in a vertical direction or a horizontal direction is zero.

13. A computer-readable storage medium, wherein a computer program is stored on the computer-readable storage medium, in a case where the computer program is run by processing device, the computer program executes steps of the image rectification method according to claim 1.

14. The method according to claim 2, wherein before correcting the second image according to the shooting parameter of the first shooting apparatus and the shooting parameter of the second shooting apparatus, the method further comprises:
adjusting the shooting parameter of the second shooting apparatus based on a preset parameter change range and an objective function that is preset.

15. The method according to claim 3, wherein before correcting the second image according to the shooting parameter of the first shooting apparatus and the shooting parameter of the second shooting apparatus, the method further comprises:
adjusting the shooting parameter of the second shooting apparatus based on a preset parameter change range and an objective function that is preset.

16. The image rectification apparatus according to claim 11, wherein the rectification module is configured to correct the second image according to an internal parameter of the first shooting apparatus, and an internal parameter and a rotation matrix of the second shooting apparatus, to obtain the second rectified image corresponding to the second image.

17. The image rectification apparatus according to claim 11, further comprising a shooting parameter adjustment module, configured to adjust the shooting parameter of the second shooting apparatus based on an objective function that is preset and a preset parameter change range.

18. The image rectification apparatus according to claim 17, wherein
the shooting parameter adjustment module is configured for:
extracting a pixel pair from the first image and the second image, wherein the pixel pair comprises a first pixel in the first image and a second pixel in the second image, and the first pixel and the second pixel correspond to an identical world coordinate;
setting the objective function to make an ordinate difference or an abscissa difference between the first pixel and a rectification point of the second pixel be the smallest, wherein the rectification point of the second pixel is obtained by following modes: correcting the second pixel according to the shooting parameter of the first shooting apparatus and an adjusted shooting parameter of the second shooting apparatus, to obtain the rectification point of the second pixel; and
adjusting the shooting parameter of the second shooting apparatus based on the objective function and the preset parameter change range.

19. The image rectification apparatus according to claim 18, wherein the shooting parameter adjustment module is configured for:
in a case where a plurality of pixel pairs are provided, for each pixel pair of the plurality of pixel pairs, calculating an ordinate difference or an abscissa difference between a first pixel and a rectification point of a second pixel and in the pixel pair; and
setting the objective function, to make a sum of ordinate differences or abscissa differences corresponding to the plurality of pixel pairs be the smallest.

20. The image rectification apparatus according to claim 18, wherein a plurality of internal parameters are provided, and the internal parameters include a focal length and a position of a main point,
the shooting parameter adjustment module is configured for performing following operations based on the objective function:
adjusting a rotation angle of the second shooting apparatus within a preset change range of a rotation angle of the second shooting apparatus, and determining a rotation matrix of the second shooting apparatus that has adjusted according to an adjusted rotation angle of the second shooting apparatus;
adjusting the focal length in the plurality of internal parameters of the second shooting apparatus within a preset change range of the focal length in the plurality of internal parameters of the second shooting apparatus;
adjusting the position of the main point in the plurality of internal parameters of the second shooting apparatus within a preset change range of the position of the main point in the plurality of internal parameters of the second shooting apparatus, wherein the main point is an intersection of an optical axis of the second shooting apparatus and a plane of the second image.
